(19) United States
(12) Patent Application Publication
(10) Pub. No.: US 2009/0024727 A1
(43) Pub. Date: Jan. 22, 2009

(54) NETWORK SYSTEM MANAGEMENT METHOD

(75) Inventors: Woong Jeon, Seoul (KR); Jong Hoon Chung, Gyeonggi-do (KR); Sang Kyun Lee, Seoul (KR); Koon Seok Lee, Kyungsang-namdo (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/885,044

(22) PCT Filed: Feb. 24, 2006
(86) PCT No.: PCT/KR06/00652

§ 371 Date: Sep. 25, 2008

Related U.S. Application Data
(60) Provisional application No. 60/762,784, filed on Jan. 27, 2006.

(30) Foreign Application Priority Data
Feb. 24, 2005 (KR) 10-2005-0015568

(51) Int. Cl. G06F 15/173

(52) U.S. Cl. 709/223

(57) ABSTRACT

A network system management method is provided. According to the method, a user inside or outside home can control or monitor the operations of appliances such as refrigerator or laundry machine through a living network such as an RS-485 network, a small output RF network, and a power line network provided inside home so that the user can perform remote control and monitor. Also, when a new device to which no address is assigned is connected in a state where a plurality of network managers are connected to the living network, only an arbitrary network manager sets and registers the address of the corresponding device and updates and manages the homenet profile suitable therefor through interface with the other network manager or a primary network manager sets and registers the address of the corresponding device and updates and manages the homenet profile suitable therefor through interface with a secondary network manager so that it is possible to effectively manage and control the devices connected to the network without redundancy error on the network to which the plurality of network managers are connected.

### 1. TECHNICAL FIELD

The present invention relates to a network system management method by which a user, for example, who is locating at home or out-of-home can effectively control household appliances such as refrigerator or laundry machine connected to a living network.

### 2. BACKGROUND ART

In general, ‘home network’ means a network in which various digital appliances are connected to one another for the user to enjoy economical home services in a convenient and safe way anytime at home or out-of-home, and due to the development of digital signal processing technology, various types of appliances such as refrigerator or laundry machine are being gradually digitalized.

On the other hand, in recent years, home network has been more advanced, since operating system and multi-media technology for appliances has been applied to digital appliances, as well as new types of information appliances have appeared.

Moreover, in a general meaning, a network which is established for providing file exchanges or internet services between personal computers and peripheral devices, a network between appliances for handling audio or video information, and a network established for home automation of various appliances such as refrigerator or laundry machine, appliance control such as remote meter reading, and the like are called a ‘living network’.

Furthermore, in the living network services in which small-scale data transmission for the remote control, or operating state monitoring of the appliances included in the living network, for example, various appliances such as refrigerator or laundry machine, is the main object of their communication, each of appliances connected to one another should be directly controlled by a network manager, which is included in the living network, with the use of the minimum required communication resources. However, its effective solution has not been provided yet, and thus it is a matter of urgency to provide its solution.

### 3. DISCLOSURE OF THE INVENTION

In order to solve the above problem, it is an object of the present invention to provide a network system management method by which a user, for example, who is locating at home or out-of-home can effectively control-household appliances such as refrigerator or laundry machine connected to a living network and, when a new device to which no address is assigned is connected to the living network, can prevent the generation of error in which the corresponding device is redundantly managed by a plurality of network managers.

In order to achieve the aforementioned object, there is provided a network system management method comprising the steps of, when a device to which no address is assigned is connected to a living network in a state where a plurality of network managers are connected to the living network, the device generating a message of requesting an address to be assigned to transmit the message and when an arbitrary network manager that receives the message transmits a message for designating an address, the network manager registering the designated address as the address of the device and then, ignoring a message for designating an address received from the other network manager.

There is provided a network system management method in a network system comprising one or more network managers, the network system management method comprising the steps of a network manager that newly participates in the network checking other network managers exist on the network, the network manager setting itself as a primary network manager when it is determined that the other network managers do not exist, and the network manager notifying the set result to devices that participate in the network.

There is provided a network system management method comprising the steps of, when a device to which no address is assigned is connected to a network in a state where a primary network manager and secondary network managers are connected to the network, the primary network manager assigning an address of the device to register the address in a homenet profile and the device to which the address is assigned notifying the assigned address to the other secondary network managers connected to the network through a transmission message.

There is provided a method of assigning addresses to network devices, the method comprising the steps of the devices receiving new addresses from a primary network manager of a network, the devices storing the received new addresses in addresses thereof, and the devices notifying the received and stored new addresses to other secondary network managers connected to the network.

### 4. BRIEF DESCRIPTION OF THE DRAWINGS

The above and other objects, features and advantages of the present invention will become apparent from the following description of preferred embodiments given in conjunction with the accompanying drawings, in which:

FIG. 1 illustrates the structure of a living network control system according to the present invention;

FIGS. 2 and 3 illustrate a master-slave driven communication structure applied to the present invention;

FIG. 4 illustrates the structure of a layer of an LnCP network applied to the present invention;

FIGS. 5 to 7 illustrate embodiments of a communication cycle service applied to the present invention;

FIG. 8 illustrates the structure of a layer of an LnCP protocol according to the present invention;

FIG. 9 illustrates an embodiment of a primitive for interface between a network management sublayer and a node parameter management layer according to the present invention;

FIG. 10 illustrates the structure of interface between layers according to an embodiment of the present invention;

FIG. 11 illustrates that a network manager manages a homenet profile according to an embodiment of the present invention;

FIG. 12 illustrates a homenet profile according to an embodiment of the present invention;

FIG. 13 is a diagram illustrating the states of a network manager for configuring a network according to an embodiment of the present invention;

FIG. 14 illustrates processes of checking a device according to an embodiment of the present invention;

FIG. 15 illustrates processes of setting logic address according to the present invention;

FIG. 16 illustrates processes of setting the addresses of the devices in the network manager according to an embodiment of the present invention;

FIG. 17 illustrates management authority processes of a new network manager according to the present invention; and

FIG. 18 illustrates processes of assigning an address to a new network manager according to the present invention.

### 5. BEST MODE FOR CARRYING OUT THE INVENTION

Hereinafter, preferred embodiments of a network system management method according to the present invention will be described in detail with reference to the attached drawings.

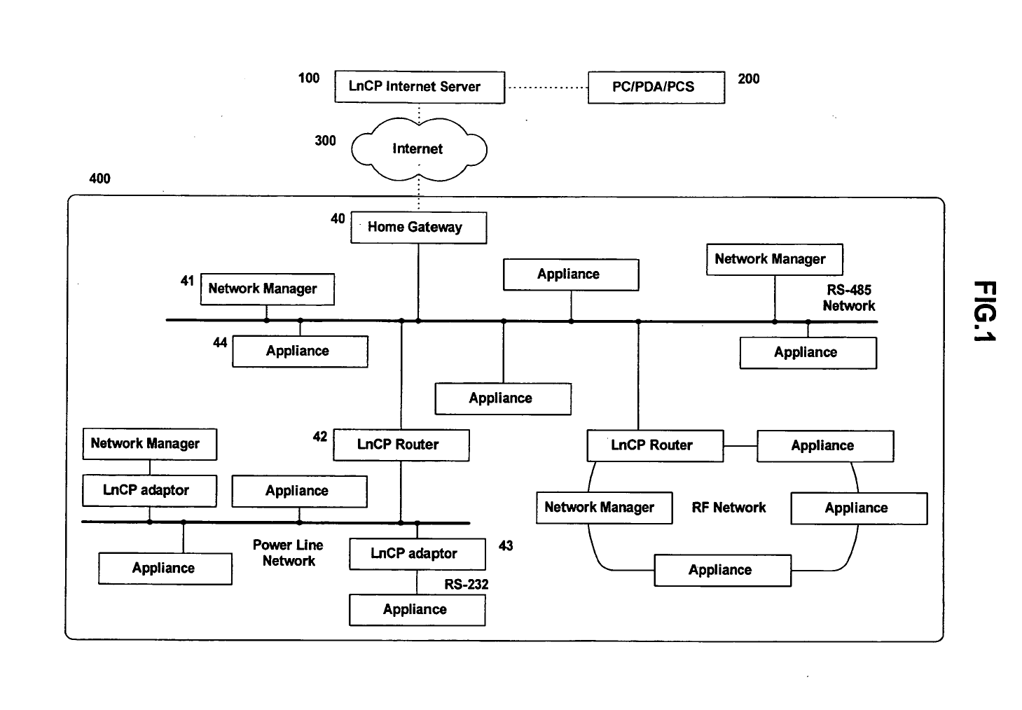

FIG. 1 illustrates the structure of a living network control system according to the present invention. For example, an LnCP Internet server 100 and a living network control system 400 to which a network control protocol newly defined according to the present invention, for example, a living network control protocol according to the present invention is applied are connected to each other through the Internet 300 and the LnCP Internet server 100 performs interface with various communication terminals 200 such as a personal computer (PC), a personal digital assistant (PDA), and a personal communication system (PCS) as illustrated in FIG. 1.

On the other hand, the living network control system 400 includes a home gateway 40, a network manager 41, an LnCP router 42, an LnCP adaptor 43, and appliances 44. As illustrated in FIG. 1, the above components use a transmission medium whose data link layer is non-standardized such as an RS-485 network or a small output RF network or a transmission medium whose data link layer is standardized such as power line communication or IEEE 802.11, ZigBee (IEEE 802.15.4).

Also, the living network control system 400 may be referred to as, for example, an LnCP network. As illustrated in FIG. 1, the LnCP network is an independent network for connecting appliances that belong to a living network to each other bag wired or wireless transmission medium in an independent home.

On the other hand, in the LnCP network, a master device that controls or monitors the operations of the other appliances and a slave device that responds to the request of the master device and gives information on change in the state thereof are connected to each other.

As illustrated in FIG. 1, the network manager 41 sets and manages the circumstances of the appliances 44 connected to the LnCP network. The appliances 44 may be directly connected to the network or may be indirectly connected to the network through the LnCP adaptor 43. The RS-485 network, the RF network, and the power line network in the LnCP network are connected to each other through the LnCP router 42.

Also, the LnCP network is connected to the Internet 300 in the outside to let a user in the outside to check or control the states of the appliances provided in the home. Therefore, the home gateway 40 connects the LnCP network and the Internet in the outside to each other. When the user accesses the LnCP Internet server 100 in the outside to perform an authentication process, the user can check or control the states of the appliances connected to the LnCP network.

The user may access the LnCP Internet server 100 by the appliances connected to the LnCP network through the home gate way 40 and then, download contents provided by the LnCP Internet server. Therefore, main characteristics of the LnCP network will be described in detail.

First, digital information appliances include micro-controllers of various performances, respectively, to perform unique functions. The function of the LnCP network according to the present invention is effectively simplified so that the LnCP network can operate in the micro-controllers of various performances and that the LnCP network can minimally use the resources of the micro-controllers mounted in the appliances. In particular, micro-controllers of low performance perform an LnCP communication function while performing functions unique to the appliances and micro-controllers of high performance support a multi-tasking function.

The LnCP network according to the present invention supports a master-slave driven communication structure, event driven communication, and a plurality of network managers and provides a four-layer structure, a communication cycle service, flexible address management, packet communication of variable length, and a standard message set.

On the other hand, the master-slave driven communication structure is used as a connection communication structure among the appliances in the LnCP network. At least one master device is required and the master device must have information on and control codes for slave devices to be controlled. At this time, the master device controls the slave devices in accordance with previously input programs or programs input by the user.

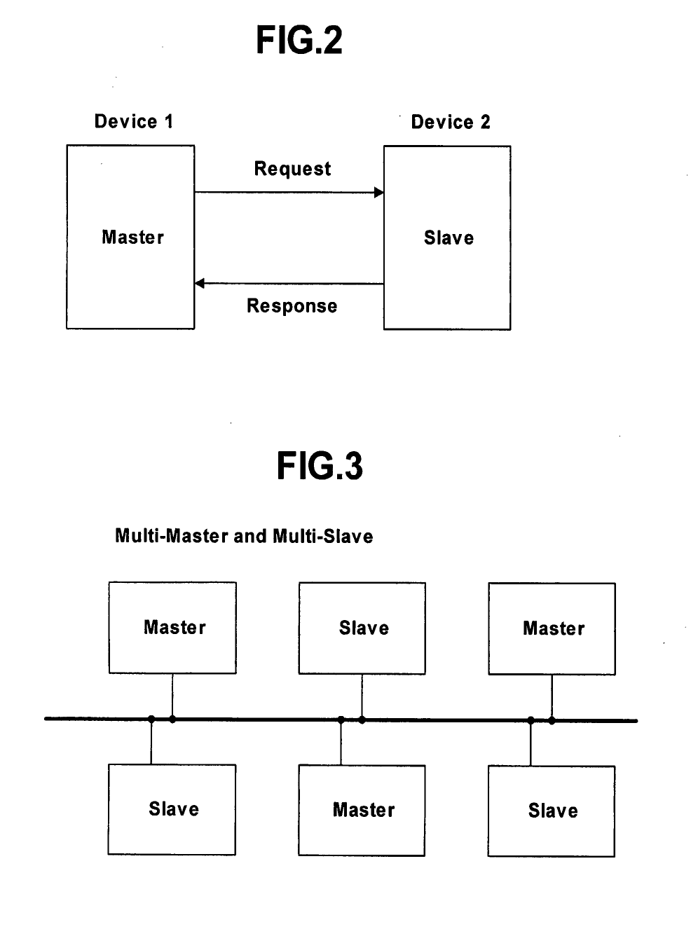

For example, a message flows between the master device and the slave device so that, as illustrated in FIG. 2, when the master device transmits a request message to the slave device, the slave device transmits a response message to the master device. As illustrated in FIG. 3, the LnCP network may have a multi-master and multi-slave driven communication structure.

The LnCP network supports an event driven communication service. For example, the user can set events required by the appliances. Then, when the events set by the user are generated while performing an arbitrary operation, the corresponding appliance informs the other appliances of the fact that the events are generated or the contents of the events or controls the states of the other appliances in response to the events.

Also, the LnCP network includes at least one network manager that sets and manages the circumstances of the appliances and may support a plurality of network managers if necessary. In this case, information items on management of the appliances must be synchronized with each other in order to cope with errors of the plurality of network managers.

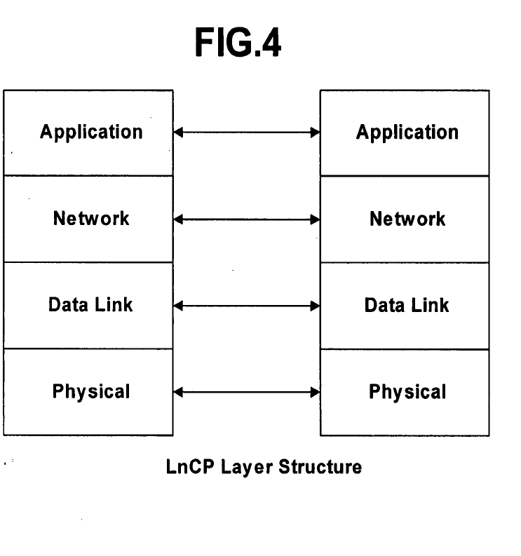

As illustrated in FIG. 4, the LnCP network includes a physical layer, a data link layer, a network layer, and an application layer. The LnCP network provides services in units of communication cycles. In the slave devices, only one communication cycle exists at a given point of time.

That is, a slave device cannot be controlled by any master device while the slave device performs a communication cycle. However, the master device can perform a plurality of communication cycles such as {1-Request, 1-Response}, {1-Request, Multi-Response}, {1-Notification}, and {Repeated-Notification} for the plurality of slave devices at the given point of time.

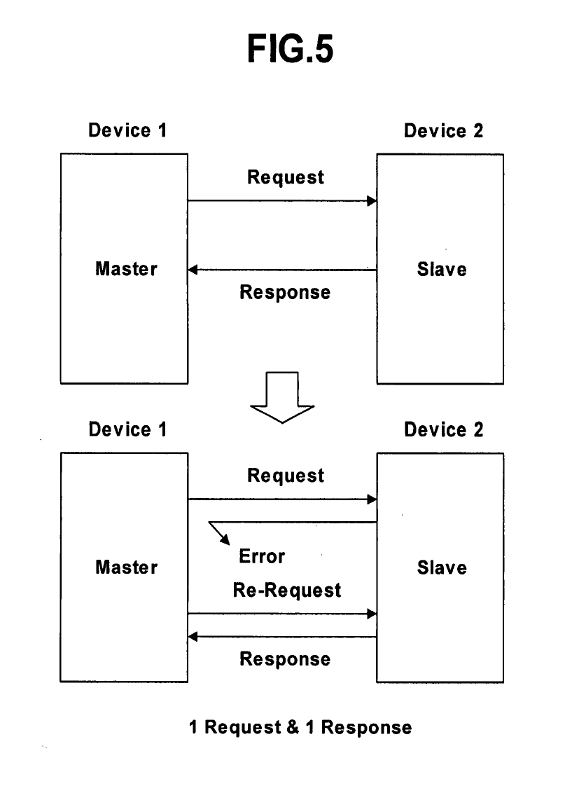

For example, in the {1-Request, 1-Response} communication cycle, one master transmits one request packet to one slave and the slave transmits one response packet in response to the request packet. When errors are generated in the received packet, as illustrated in FIG. 5, the master transmits a re-request packet and the slave re-transmits the response packet for the re-request packet.

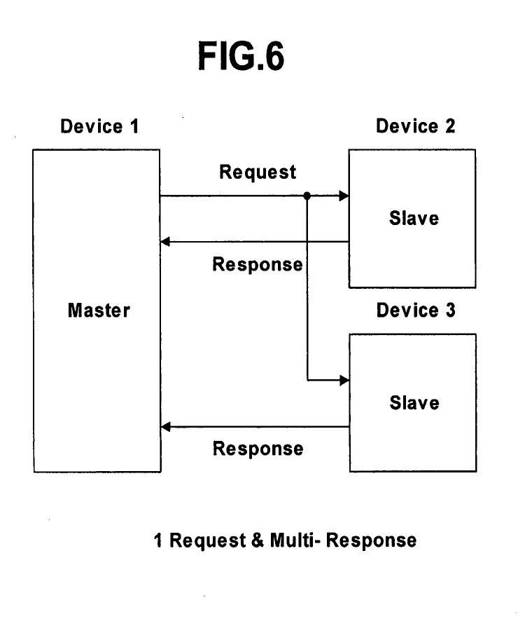

Also, in the {1-Request, Multi-Response} communication cycle, as illustrated in FIG. 6, one master transmits one request packet having an address group to a plurality of slaves and the slaves transmit one response pack for the request packet. The master completes the cycle with the lapse of allowed maximum reception time. At this time, although errors are generated in the response packet received from the slaves, the master ignores the errors.

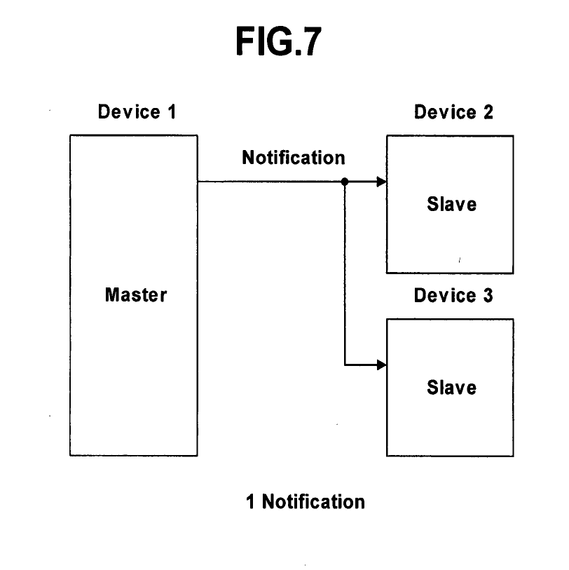

In the {1-Notification} communication cycle, as illustrated in FIG. 7, a master device transmits one notification packet to one or a plurality of devices and then, immediately completes the cycle. In the {Repeated-Notification} communication cycle, in order to secure transmission reliability of the {1-Notification} communication cycle, the same packet is repeatedly transmitted and then, the communication is completed.

On the other hand, the PnCP network supports flexible management of addresses. For example, addresses are assigned to the appliances including the LnCP function, respectively, when the appliances are forwarded from a factory so that a network is automatically configured without intervention of the user. At this time, since the same kind of appliances are initialized by the same address, the network manager has an algorithm of assigning a unique address when the appliances are connected to each other.

Also, in the LnCP network, a unique group address is assigned to the same kind of appliances so that it is possible to perform group communication using one message. Various kinds of appliances are distinguished from each other by clusters in accordance with needs of the user so that a group address is assigned to each cluster.

The PnCP network supports a packet communication of variable length. For example, when contents such as application programs related to manipulation of the appliances are downloaded or when data stored in the appliances are uploaded, the length of the packet is controlled using exchanged information items on the sizes of the buffers of the appliances.

Also, the LnCP network provides a standard message set. For example, the application layer defines the standard message set suitable for the various appliances so that the master device can control the other appliances. The message set is divided into a common area message set for basic LnCP communication, an application area message set for supporting the unique functions of the appliances, and a developer area message set for providing the unique function of a manufacturing company.

On the other hand, the message set may be increased if necessary and factors may be added to the previously defined message. Hereinafter, the layer structure that is one of the main characteristics of the LnCP network according to the present invention will be described in detail.

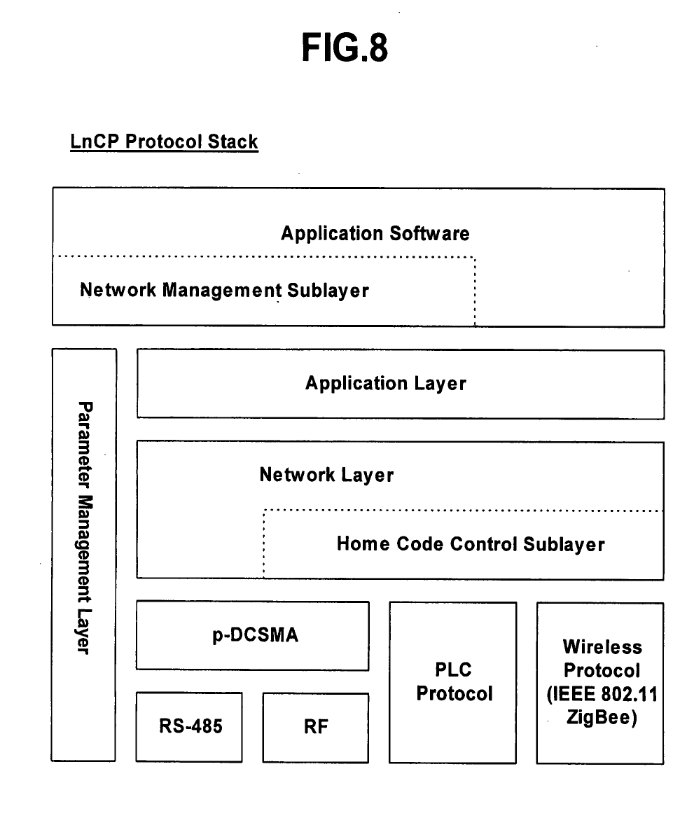

FIG. 8 illustrates the layer structure of the LnCP protocol according to the present invention. As described above, the LnCP network according to the present invention includes the physical layer, the data link layer, the network layer, and the application layer in order to control and monitor the operations of the appliances such as a refrigerator and a washing machine.

On the other hand, the physical layer performs physical interface between devices and transmits and receives physical signals such as bits to be transmitted. The transmission medium whose data link layer is non-standardized such as RS-485 and the small output RF and the standardized wired and wireless transmission medium such as power line communication or Ethernet, IEEE 802.11, and ZigBee may be used as the physical layer. In the LnCP network, the LnCP adaptor may be used as an additional physical layer in order to realize the physical layers of the devices.

The data link layer performs a medium access control (MAC) for using a shared transmission medium. When the data link layer uses the non-standardized transmission medium, the LnCP network must use a probabilistic delayed carrier sense multiple access (p-DCSMA) as the MAC protocol.

However, when the data link layer uses the standardized transmission medium, the LnCP network may use a MAC function specified in the corresponding protocol.

On the other hand, as illustrated in FIG. 8, when the LnCP network is configured using the dependent transmission medium such as the power line communication or the IEEE 802.11, ZigBee, and the small output RF, a home code control sublayer sets, manages, and processes home codes for logically distinguishing a network. The home code control sublayer is not preferably realized when the network is physically distinguished by the independent transmission medium such as the RS-485.

The network layer manages the addresses of the appliances and controls transmission and reception in order to perform reliable network connection between the devices. The application layer controls transmission and reception and controls flow for download and upload services in order to perform the services of application software.

The application layer defines the message set in order to manage the network or to control and monitor the appliances. The application software performs functions unique to the appliances and exchanges data with the application layer through the interface defined by the application layer.

As illustrated in FIG. 8, the network management sublayer manages node parameters to set the node parameters and configures and manages the network. A node parameter management layer may set or read the node parameters used for the respective layers in accordance with the request of the network management sublayer.

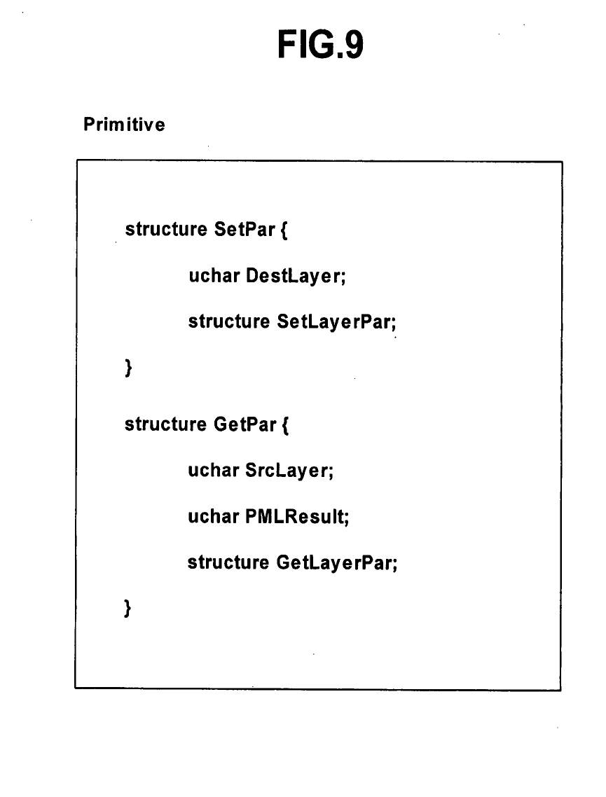

A primitive for interface with the network management sublayer is divided into a primitive (structure SetPar) for transmitting the values of the node parameters from the network management sublayer to the node parameter management layer and a primitive (structure GetPar) for transmitting the values of the node parameters from the node parameter management layer to the network management sublayer as illustrated in FIG. 9.

On the other hand, ‘uchar DestLayer’ that illustrates layers for transmitting the values of the node parameters and structure SetLayerPar as a node parameter for each layer whose value varies in accordance with the value of DestLayer are recorded in the primitive (structure SetPar) for transmitting the values of the node parameters to the node parameter management layer. The DestLayer is ‘1’ when the layer for transmitting the values of the node parameters is the application layer, ‘2’ when the layer for transmitting the values of the node parameters is the network layer, ‘3’ when the layer for transmitting the values of the node parameters is the data link layer, and ‘4’ when the layer for transmitting the values of the node parameters is the physical layer.

The SetLayerPar is ‘SetALPar’ when the layer for transmitting the values of the node parameters is the application layer, ‘SetNLPar’ when the layer for transmitting the values of the node parameters is the network layer, ‘SetDLLPar’ when the layer for transmitting the values of the node parameters is the data line layer, and ‘SetPHYPar’ when the layer for transmitting the values of the node parameters is the physical layer.

‘ucharSrcLayer’ that illustrates layers for transmitting the values of the node parameters, ‘uchar PMLResult’ that illustrates whether the values of the node parameters are successfully received from the respective layers, and ‘structure GetLayerPar’ as a node parameter for each layer whose value varies in accordance with the value of SrcLayer are recorded in the primitive (structure GetPar) for transmitting the values of the node parameters to the network management sublayer. The SrcLayer is ‘1’ when the layer for transmitting the values of the node parameters is the application layer, ‘2’ when the layer for transmitting the values of the node parameters is the network layer, ‘3’ when the layer for transmitting the values of the node parameters is the data link layer, and ‘4’ when the layer for transmitting the values of the node parameters is the physical layer.

The PMLResult is PAR_OK(1) when the values of the node parameters are successfully received from the respective layers and PAR_FAILED (0) when the node parameters are not successfully received from the respective layers. The GetLayerPar is ‘RptALPar’ when the layer for transmitting the values of the node parameters is the application layer, ‘RptNLPar’ when the layer for transmitting the values of the node parameters is the network layer, ‘RptDLLPar’ when the layer for transmitting the values of the node parameters is the data link layer, and ‘RptPHYPar’ when the layer for transmitting the values of the node parameters is the physical layer.

On the other hand, the node parameter used for the node parameter management layer ‘const unit ParTimeOut’ illustrates stand-by time (ms) for receiving RptALPar (RptNLPar, RptDLLPar, or RptPHYPar) after transmitting GetALPar (GetNLPar, GetDLLPar, or GetPHYPar) to each layer.

The node parameter management layer transmits the primitive SetALPar, SetNLPar, SetDLLPar, or SetPHYPar to the layer specified in the primitive when the SetPar primitive is received from the network management sublayer and ignores the node parameter in which the values of all bits are ‘1’ in the primitive received from each layer (for example: 0xFF and 0XFFFF).

Also, the node parameter management layer transmits the primitive GetALPar, GetNLPar, GetDLLPar, or GetPHYPar to the layer specified in the primitive when the GetPar primitive is received from the network management sublayer and transmits the value of PARResult, that is, PAR_OK to the network management sublayer when RptALPar, RptNLPar, RptDLLPar, or RptPHYPar primitive is received from the network management sublayer. When the primitive is not received from each layer within ParTimeOut time, the node parameter management layer transmits the value of PARResult, that is, PAR_FAILED to the network management sublayer.

On the other hand, the network management sublayer manages the node parameters to set the node parameters in each device, configures the network, sets circumstances, and manages the operation of the network. When requested by application software and the master, the network management sublayer sets or reads the values of the following node parameters in the corresponding layer.

For example, in the application layer, the values of the node parameters such as AddressResult, NP_Alivelnt, SvcTimeOut, and NP_BufferSize are set or read. In the network layer, the values of the node parameters NP_LogicalAddress, NP_ClusterCode, NP_HomeCode, and SendRetries are set or read. In the data link layer, the value of the node parameter MinPktInterval is set or read. In the physical layer, the value of the node parameter NP_bps is set or read.

In particular, the network management sublayer of a slave sets or reads the values of the node parameters in the corresponding layer through the node parameter management layer and transmits the results to the application layer through the primitive User ResSend primitive when the primitive UserReqRcv including application serves that belong to ‘a device node parameter setting service’ or ‘a device node parameter acquiring service’ is received from the application layer. The application services for managing the node parameters of each layer are as follows.

For example, in the application layer, the application services SetOption, SetAliveTime, SetClock, and GetBufferSize are included. In the network layer, the SetTempAddress, SetAddress, and GetAddress application services are included. In the data link layer, no application service is included. In the physical layer, the SetSpeed service is included.

On the other hand, the network management sublayer manages the network, for example, configures the LnCP network, sets the circumstances of the network, and manages the operation of the network. A common network management function operates in the application layer of the master. Some of a function of synchronizing information items on the network with each other in a plurality of network management periods operates in the application layer of the slave.

Interface with the application layer is divided into interface with the application layer of the slave and interface with the application layer of the master. The primitives UserReqRcv and UserResSend are used for the interface with the application layer of the slave. The primitives UserReq, UserDLReq, UserULReq, UserRes, UserEventRcv, and ALCompleted are used for the interface with the application layer of the master.

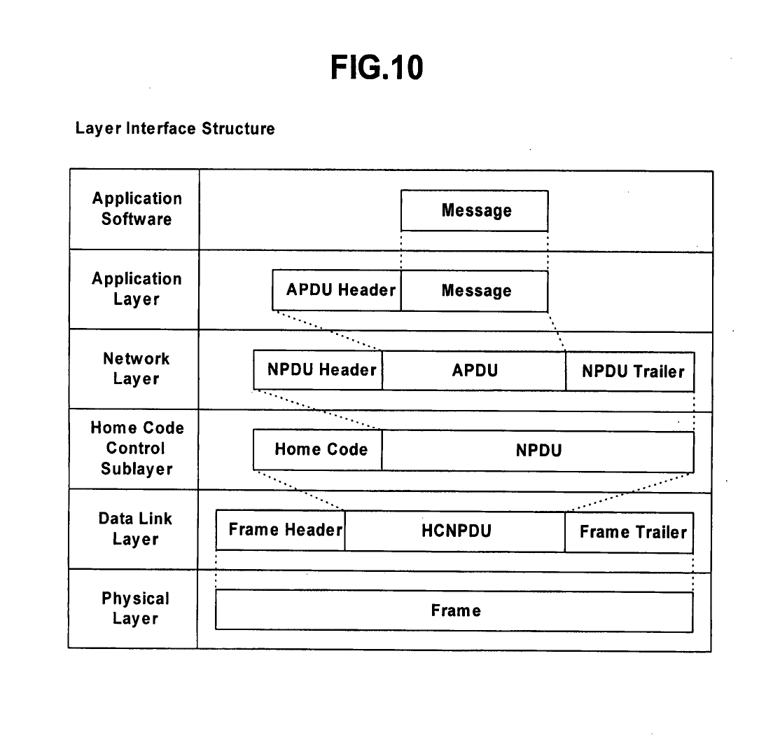

In a method of performing interface between layers in a living network control system according to the present invention, as illustrated in FIG. 10, information items on the headers and the trailers required by the respective layers are gathered in a protocol data unit (PDU) received from an upper layer and are transmitted to a lower layer.

For example, an application layer PDU (APDU) as a packet transmitted between the application layer and the network layer is composed of APDU header and message and a network layer PDU (NPDU) as a packet transmitted between the network layer and the data link layer or the home code control sublayer is composed of an NPDU header, an NPDU trailer, and the APDU such as the APDU and the address of the APDU, the address of the destination appliance, and the kind of a packet determined in accordance with the importance of a message to be transmitted.

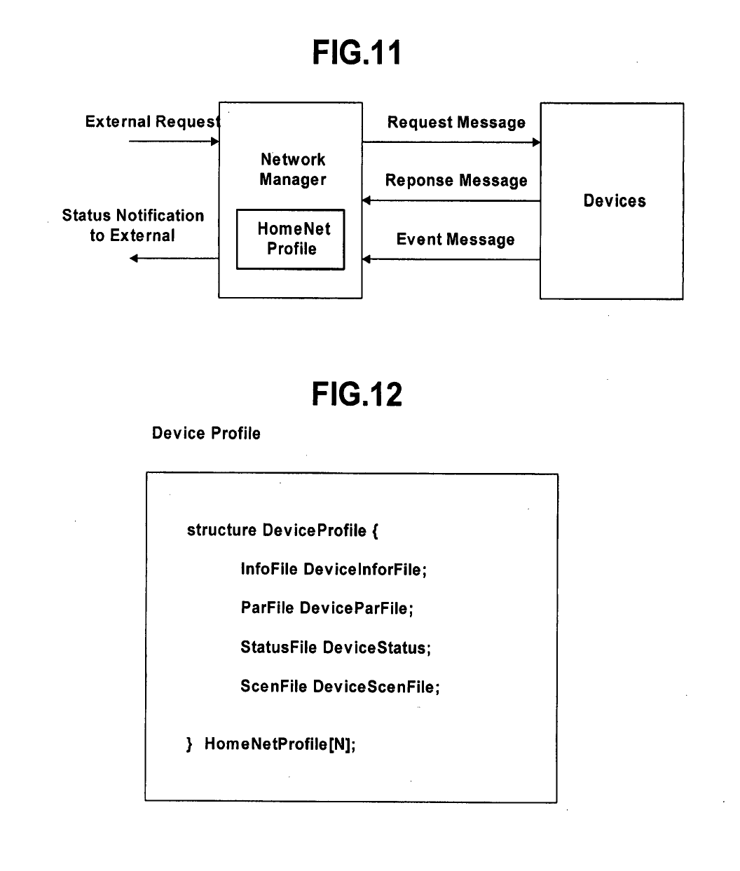

On the other hand, the network manager according to the present invention continuously manages information on all devices that constitute the LnCP network and provides network services to the user using the homenet profile as illustrated in FIG. 11.

Also, the network manager configures the network to set circumstances for the operations of the devices connected to the LnCP network and updates the homenet profile in accordance with the result of communication with a normal device after completing network configuration.

The network is configured when messages for configuring the network is received from the outside of the network manager or the devices as illustrated in FIG. 11 after power is applied to the appliances that belong to the LnCP network and the network manager.

On the other hand, when the network configuration is completed as described above, the network manager performs a common operation of controlling the user or managing the events generated by the devices. The homenet profile according to the present invention is composed of device profiles having information on the devices connected to the network.

Also, a device information file for a single device stored in the network manager ‘InfoFile DeviceInforFile’, a node parameter file ‘ParFile DeviceParFile’, a device operation file ‘StatusFile DeviceStatus’, a scenario file ‘ScenFile DeviceScenFile’, and the number of devices registered in the network manager ‘HomeNetProfile[N]’ are recorded as illustrated in FIG. 12.

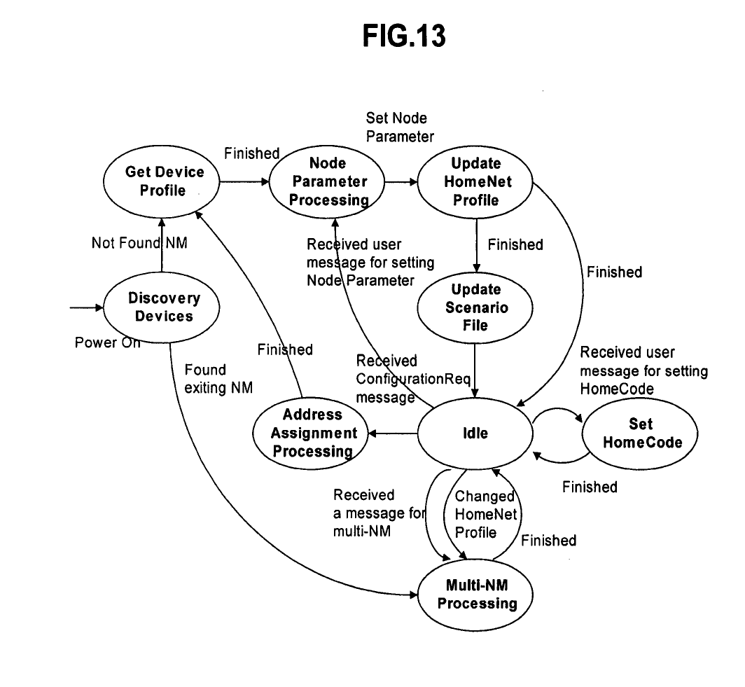

As illustrated in FIG. 13, the network manager configures the LnCP network, for example, checks the devices connected to the LnCP network, sets the home codes, sets the logical addresses of the devices, sets the values of the other node parameters, sets scenario programs, and configures the homenet profile.

On the other hand, the network manager requests the other network managers to update the homenet profile whenever the contents of the homenet profile are changed during the network configuration. In order to perform such an operation, the network manager transmits the request message to the application layer using the primitive UserReq and receives the primitives UserRes and ALCompleted.

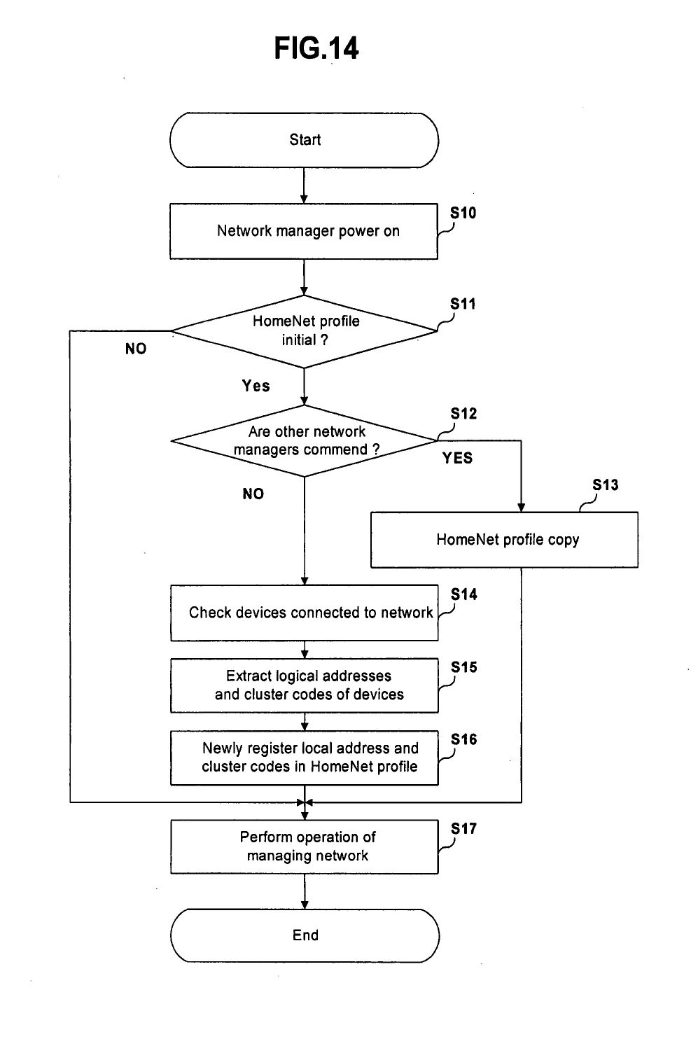

Also, as illustrated in FIG. 14, when there is no device registered in the homenet profile at the time where power is supplied (S10), that is, when the homenet profile is in the initial state (S11), the network manager determines whether the other network managers are connected to the network (S12).

For example, the network manager determines whether the other network managers are connected to the network using the GetAddress service. At this time, the values of the factors of ‘DstAddress=0x00FF’ whose receivers are all of the devices and response message stand-by time ‘TimeOut (for example: 10,000 ms) are used for the primitive UserReq transmitted to the application layer.

When it is determined that the other network managers are connected to the network, for example, when the DeviceAddressAckRes message is received, the homenet profiles are copied from the other network managers using the GetDeviceList service (0xFF34) (S13) to complete checking the devices. The values of the factors of the node address ‘DstAddress=0xXXYY’ of the network manager that transmits the DeviceAddressAckRes message and response message stand-by time ‘TimeOut (for example: 2,500 ms) are used for the primitive UserReq transmitted to the application layer when the GetDeviceList service is used.

On the other hand, when it is determined that the other network managers are not connected to the network, the devices connected to the network are checked using the GetAddress service (0xFF07) (S14). At this time, the values of the factors of ‘DstAddress=0xFFFF’ whose receivers are all of the devices, the Acknowledged transmission service NLService=0, and the response message stan-by time ‘TimeOut (for example: 10,000 ms) are used for the primitive UserReq transmitted to the application layer.

Also, when the GetAddress service is processed, the logical addresses and the cluster codes of the devices are extracted from the received response message (S15) to be newly registered in the homenet profile (S16). Then, the network is configured and managed using the homenet profile in which information items on the devices are newly registered or the homenet profiles copied from the other network managers through the above-described process (S17).

On the other hand, in the case where the number of devices that transmit the response message is no less than the proper communication number, for example, 10 when the GetAddress service is processed, the operation of checking the devices (S14) is repeatedly performed and the devices that are registered in the homenet profile but do not receive the response message since power is turned off are checked using the GetAddress service. At this time, the values of the factors of ‘DstAddress=0xXXYY’ corresponding to the product code XX and the logical address YY and the response message stand-by time ‘TimeOut (for example: 2,500 ms)’ are used for the primitive UserReq transmitted to the application layer.

The network manager sets the logical addresses of the devices. For example, the devices whose logical addresses are not set transmit the ConfigurationReq message at time interval AddressReqInt when the logical addresses of the devices are 0x00. When the ConfigurationReq message is received from the devices through the NotiPlugIn service, the network manager determines the number of devices whose addresses are requested to be set and performs an address setting algorithm for the plurality of devices or the single device.

On the other hand, when the ConfigurationReq message is received, the network manager waits for the ConfigurationReq message from the other devices for predetermined time, for example, 2×AddressReqInt from the point of time where the ConfigurationReq message is received. When the ConfigurationReq message is received from the same transmitter address no less than two times within the time 2×AddressReqInt, it is determined that the plurality of same kinds of devices exist. If not, it is determined that the single device exists.

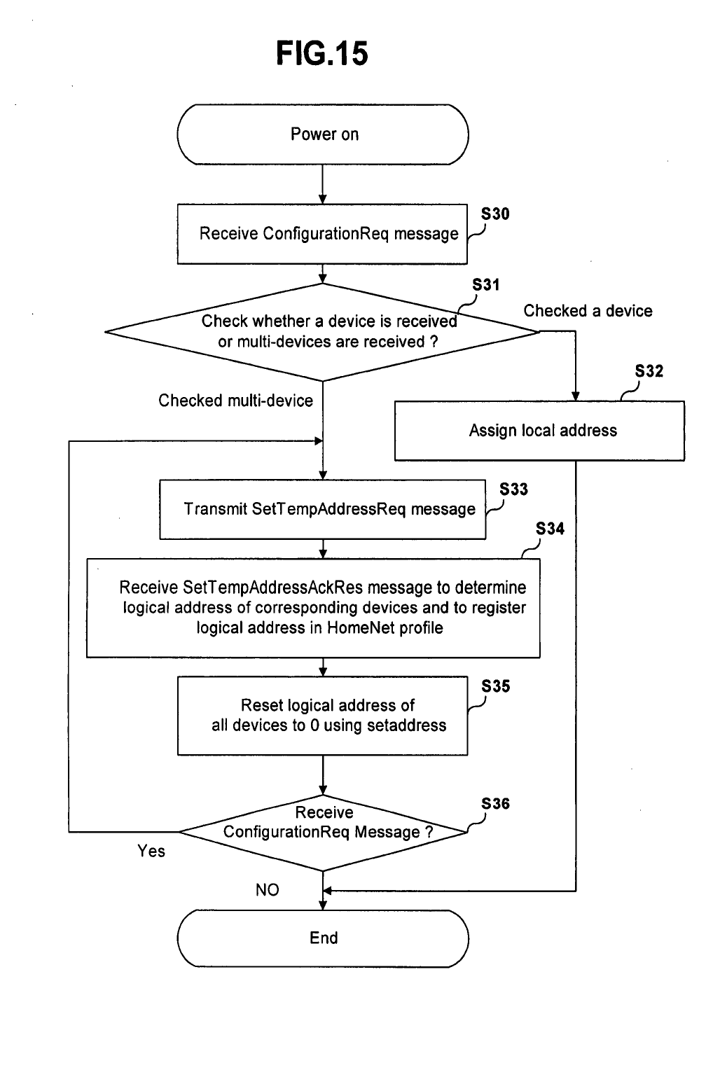

For example, as illustrated in FIG. 15, when the ConfigurationReq message is received from an arbitrary device in a state where power is turned on (S30), the network manager extracts the product code of the transmitter to check whether the single device exists or the plurality of devices exist (S31). For example, when the transmitter is the single device, the product code ‘0xXX’ of the transmitter is extracted and the largest logical address value ‘0xYY’ assigned to the devices having the same product code is checked in the homenet profile.

Then, the logical address ‘0xYY+1’ is assigned to the device that transmits the ConfigurationReq message using the SetAddress service (0XFF0F) (S32). At this time, the values of the factors of the node addresses of the devices that transmit the ConfigurationReq message ‘DstAddress=0xXX00’ and the response message stand-by time ‘TimeOut (for example: 2,500 ms)’ are used for the primitive UserReq transmitted to the application layer.

Also, the network manager registers the address of the new device in the homenet profile and requests to update the homenet profiles of the other network managers through interface with the other network managers using the NotiDeviceAd service (00xFF31).

On the other hand, when the transmitter is the plurality of devices, that is, when the same message ConfigurationReq is received a plurality of times, the product code ‘0xXX’ of the transmitter is extracted and the largest logical address value ‘0xYY’ assigned to the devices having the same product code is checked in the homenet profile.

Then, the SetTempAddressReq message is transmitted to the devices that transmit the ConfigurationReq message using the SetTempAddress service (0xFF0E) (S33) so that the plurality of devices select a temporary logical address from the logical addresses ‘0xYY+Nd+1 to 0xFD’.

On the other hand, the Nd represents the number of devices whose logical addresses can be set by previously set processes. The values of the factors of the node addresses of the devices that transmit the ConfigurationReq message ‘DstAddress=0xXX00’ and response message stand-by time ‘TimeOut (for example: 29,000 ms)’ are used for the primitive UserReq transmitted to the application layer.

Also, the network manager sequentially determines the logical addresses of the devices that transmit the SetTempAddressAckRes message that is the response message corresponding to the SetTempAddressReq message using the SetAddress service from ‘0xYY+1’ and registers the address of the new device in the homenet profile (S34).

Then, the network manager requests to update the homenet profiles of the other network managers through interface with the other network managers using the NotiDeviceAd service (0xFF31). At this time, the values of the factors of the node addresses of the devices that select the temporary logical address ‘DstAddress=0xXXMM’ and the response message stand-by time ‘TimeOut (for example: 2,500 ms)’ are used for the primitive UserReq transmitted to the application layer when the SetAddress service is used.

On the other hand, the network manager resets the logical addresses of all of the devices whose logical addresses are ‘0xFE’ using the SetAddress service (S35). At this time, the values of the factors of the node addresses of the devices whose determined addresses 0xZZ are redundant or that select the same temporary logical address 0xNNj ‘DstAddress=0xXXFE’, the repeated message transmission service ‘Aservice=2’, and the response message stand-by time ‘TimeOut (for example: 1,000 ms)’ are used for the primitive UserReq transmitted to the application layer.

Also, when the ConfigurationReq message is received (S36), the network manager repeatedly performs a series of operations of transmitting the SetTempAddressReq message. When the ConfigurationReq message is not received, the network manager completes the operation of setting the logical addresses of the devices.

On the other hand, the network manager sets the option value NP_OptionVal and the notification period time value NP_AliveInt that illustrate whether to properly generate events in accordance with the number of devices connected to the LnCP network and synchronizes the time data of all of the devices in the network when the logical addresses of the devices are newly set or the new device whose address is previously set is found.

The cluster codes of the devices are set in order to determine the group of devices in accordance with the object of the user. For example, the option value NP_OptionVal of the devices is set as 0xFFFF FFFF using the SetOption service (0xFF0D) and the detailed option values may be set as transmission of the AliveEvent message ‘AliveEventOption=1’ and transmission of all event messages excluding the AliveEvent message ‘EventOption=1’.

At this time, the values of the factors of all of the devices connected to the network ‘DstAddress=0xFFFF’, the repeated message transmission service ‘ALService=2’, and the response message stand-by time ‘TimeOut (for example: 1,000 ms)’ are used for the primitive UserReq transmitted to the application layer.

On the other hand, the notification period time NP_AliveInt is a variable for sensing the offline state of the devices caused by pulling out a plug or manipulating a power switch and the value thereof is controlled in accordance with the number of devices connected to the LnCP network. For example, the average interval at which the AliveEvent message is received by the network manager using the SetAliveTime service (0xFF16) is preferably larger than 30 seconds.

That is, when the number of devices connected to the physically same network is N, the NP_AliveInt is set to be larger than 30×N (seconds). At this time, the values of the factors of all of the devices connected to the network ‘DstAddress=0xFFFF’, the repeated message transmission service ‘ALService=2’, and the response message stand-by time ‘TimeOut (for example: 1,000 ms)’ are used for the primitive UserReq transmitted to the application layer.

Then, the network manager sets the time set therefor for the other devices using the SetClock service (0xFF17).

On the other hand, the cluster code that is a value for distinguishing the group of devices from each other based on various standards such as the places in which the devices are provided and the power consumptions of the devices can be set using the SetAddress service (0xFF0F). At this time, the values of the factors of the node address of the device selected by the user ‘DstAddress=0xXXYY’, and the response message stand-by time ‘TimeOut (for example: 2,500 ms)’ are used for the primitive UserReq transmitted to the application layer.

Then, when an operation of ‘setting cluster codes’ is performed through user interface, the network manager displays ‘operation checking’ buttons capable of checking information items on the devices registered in the homenet profile and the operations of the devices and lets the user to manually input the cluster codes of the devices.

Also, when the user inputs the cluster codes of the devices, the cluster codes of the devices selected by the user are set using the SetAddress service (0xFF0f) and are registered in the homenet profile. When the user executes the ‘operation checking’ buttons in order to set the cluster codes while checking the operations of the devices, the user checks the operations of the devices and manually inputs the cluster codes.

Then, after setting the cluster codes of the devices selected by the user using the SetAddress service (0xFF0F) and registering the cluster codes in the homenet profile, the network manager collectively controls the group of devices provided in the place desired by the user using the cluster codes.

On the other hand, when the plurality of network managers operate on the LnCP network, a basic mutual related operation between the network managers is required. For example, the network manager that operates as the home gateway may be fixedly used as the node address 0x0000, however, the other network manager may be realized in a product having a unique function such as a television set or in a product having only a network management function.

The network manager whose product code is not 0x00 must start to operate after assigning a logical address. The initial node address is 0x0000 and the logical address is set through a series of processes after power is supplied.

For example, when the other network manager exists on the network, the network manager sets the logical address through interface with the network manager. When the other network manager does not exist on the network, the network manager selects a temporary logical address, for example, an arbitrary value 0xXX in the range of 0x01 to 0xFD to set the value as the logical address thereof.

On the other, when the packet is damaged due to problems in the transmission medium on the LnCP network, information items on product states may not coincide with each other between the network managers that are masters. In order to synchronize the information items with each other, a securing method on programs is preferably performed in the application layers of the network managers.

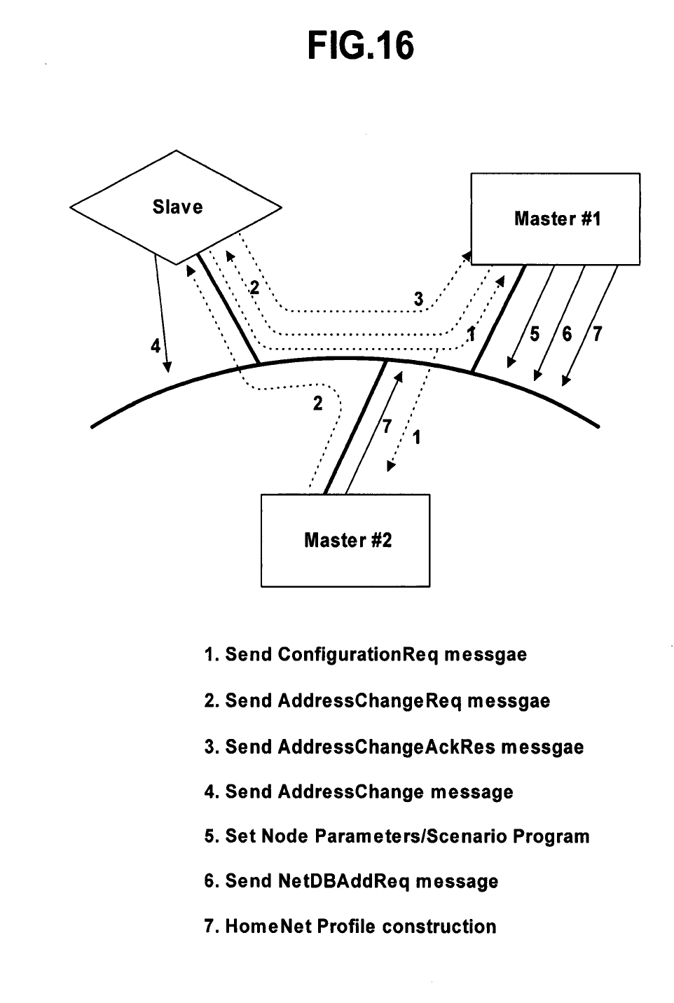

FIG. 16 illustrates processes of registering the devices when the plurality of network managers exist according to an embodiment of the present invention. When a new device, for example, Slave is connected to the network in a state where the plurality of network managers, for example, Master #1 and Master #2 have a function of registering products, the Slave transmits the ConfigurationReq message that requests an address to be assigned and the Master #1 and the Master #2 receive the ConfigurationReq message.

In the case where the user who wishes to add the Slave to the Master #1 first performs processes of registering the devices and then, another user accidentally registers the Slave in the Master #2, when the Slave is first registered by the Master #1, a message for registering the Slave sent by the Master #2 is ignored.

For example, when no address is assigned to an air conditioner, the initial address is 0x0200. When the Slave is registered in the Master #1 so that the address is changed into 0x0201, although a temporary address is received through registration processes performed by the Master #2, the Slave ignores the address to prevent the Slave from being redundantly registered in the Master #2 after being registered in the Master #1.

The Master #1 in which a new device is registered transmits the DeviceAddReq message of the NotiDeviceAdd service (0xFF31) to the other network manager, for example, the Master #2. At this time, the group address of the network manager ‘DstAddress=0x00FF’, the repeated message transmission service ‘ALService=2’, and the response stand-by time ‘TimeOut (for example: 1,000 ms)’ are used for the primitive UserReq transmitted to the application layer.

On the other hand, the network manager Master #2 that receives the DeviceAddReq message gets the profile of the device whose information is modified using the GetNetProfile service (0xFF35) and updates the homenet profile thereof. At this time, the node address of the network manager that receives the DeviceModifyReq message ‘DstAddress=0x00XX’, the repeated message transmission service ‘ALService=2’, and the response stand-by time ‘TimeOut (for example: 1,000 ms)’ are used for the primitive UserReq transmitted to the application layer.

The network manager that deletes a device from the homenet profile informs all of the network managers connected to the network of the fact that the corresponding device is deleted. The network manager first deletes the device using the NotiDeviceDel service (0xFF1B) and then, deletes the corresponding device from the homenet profile thereof.

Then, the network manager transmits the DeviceDel message of the NotiDeviceDel service (0xFF32) to all of the network managers. At this time, the group address of the network manager ‘DstAddress=0x00FF’, the repeated message transmission service ‘ALService=2’, and the response stand-by time ‘TimeOut (for example: 1,000 ms)’ are used for the primitive UserReq transmitted to the application layer.

On the other hand, the network manager that receives the DeviceDelReq message deletes information on the device deleted from the homenet profile thereof. When the information on the device registered in the homenet profile is modified, the network manager transmits the DeviceModifyReq message of the NotiDeviceModify service (0xFF33). At this time, the group address of the network manager ‘DstAddress=0x00FF’, the repeated message transmission service ‘ALService=2’, and the response stand-by time ‘TimeOut (for example: 1,000 ms)’ are used for the primitive UserReq transmitted to the application layer.

Also, the network manager that receives the DeviceModifyReq message gets the profile of the device whose information is modified using the GetNetProfile service (0xFF35) and updates the homenet profile thereof. At this time, the node address of the network manager that receives the DeviceModifyReq message ‘DstAddress=0x00XX’, the repeated message transmission service ALService=2′, and the response stand-by time ‘TimeOut (for example: 1,000 ms)’ are used.

The network manager can get information items on the devices connected to the network at one time from the other network manager using the GetDeviceList service (0xFF34).

On the other hand, according to another embodiment of the present invention, a case in which a plurality of network managers are connected to a living network to set an arbitrary network manager as a primary network manager (P-NM) and to set the other network managers as secondary network managers (S-NM) will be described.

Meanwhile the primary network manager has a network management function and a network management authority, the secondary network managers have a network management function but assign the management authority to the primary network manager so that the secondary network managers do not use the network management function.

On the other hand, when a new network manager is connected to the living network in a state where no network managers are connected to the living network, a new network manager is connected to the living network in a state where the primary network manager is connected to the living network, or a new network manager is connected in a state where network managers are connected to the living network, however, there is no primary network manager and when the connection of the primary network manager to the living network is released, an exchange of network management authority is performed.

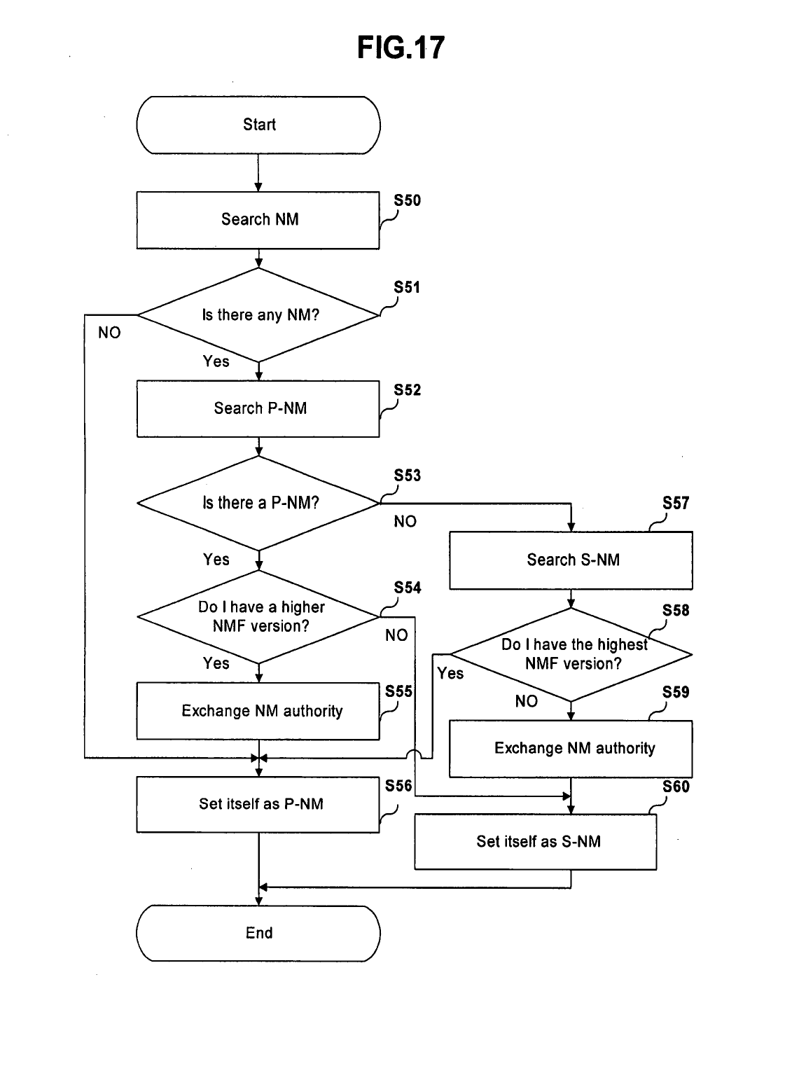

For example, as illustrated in FIG. 17, a new network manager that newly participates in the living network checks whether another network manager exists using a GetAddress service (S50) to check whether a primary network manager exists using an NMSearch service (S52) when it is determined that another network manager exists (S51) and to set the new network manager itself as the primary network manager when it is determined that another network manager does not exist.

When the primary network manager exists (S53), the new network manager checks whether the network management function version thereof is higher than the network management function version of the primary network manager to receive a network management authority and to set the new network manager itself as the primary network manager using an NMAuthExchange service (S56) when it is determined that the new network manager itself has a higher network management function version (S54).

On the other hand, when the primary network manager does not exist on the living network, a new network manager searches secondary network managers through the NMSearch service (S57) to give a network management authority to the secondary network managers using the NMAuthExchange service (S59) and to set the new network manager itself as a secondary network manager (S60) when it is determined that the secondary network managers having a network management function version higher than the network management function version of the new network manager itself exist (S58).

On the other hand, when the searched secondary network managers have the network management function version higher than the network management function version of the new network manager, the new network manager sets itself as a primary network manager and the network manager set as the primary network manager through the above processes notifies the change to the other network managers and the devices using a NotiNMChange service.

On the other hand, when the connection of the primary network manager to the living network is released, the exchange of network management authority is performed. For example, the primary network manager transmits AliveEvent at uniform intervals and the secondary network manager receives the AliveEvent. When the AliveEvent is not received for a predetermined time, it is determined that the connection of the primary network manager to the living network is released.

Then, the network management function versions of the other secondary network managers connected to the living network are checked so that the secondary network manager having the highest version has the network management authority. For example, since the plurality of secondary network managers simultaneously check that the primary network manager is plugged out, an operation of re-checking the primary network manager may be performed again in accordance with the selection of a user.

On the other hand, in order for the plurality of network managers to operate on one network, the network managers must assign logical addresses in the range of 0x0001 to 0x00Fd. The network managers may be realized with respect to products having unique functions such as a TV and may be realized with respect to products having only the network management function. In the case of the network manager whose product code is 0x00, the initial node address is 0x0000 and a logical address is set in accordance with a next process after power is supplied.

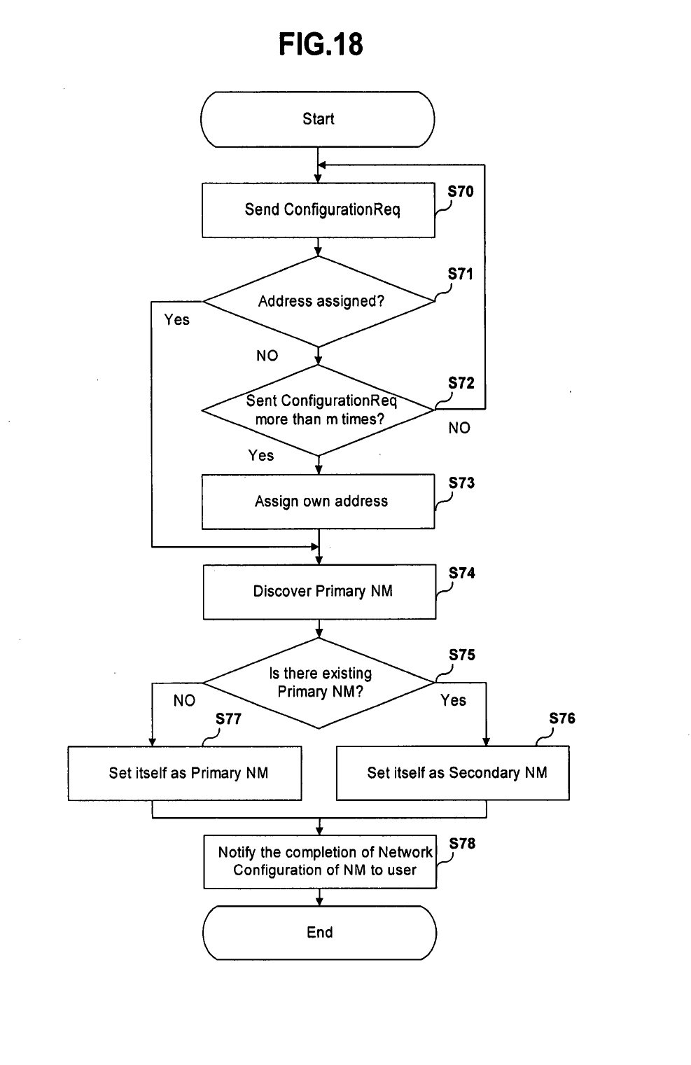

For example, as illustrated in FIG. 18, a new network manager newly connected to the living network transmits a ConfigurationReq message to the living network (S70). When a primary network manager exists, an address is assigned to the new network manager that transmits the ConfigurationReq message.

On the other hand, when the new network manager does not receive the address (S71), the ConfigurationReq message is transmitted for a uniform number of times (for example: m times) in accordance with communication speed (S72). Then, when the address is not received, an arbitrary value 0x00 is selected in the range of 0x01 to 0xFD to assign an arbitrary logical address to the new network manager (S73).

Then, the new network manager searches the primary network manager that previously exists using the NMSearch service (S74) to set the new network manager itself as a secondary network manager (S76) when the primary network manager is searched (S75) and to set the new network manager itself as a primary network manager (S77) and to notify a user that the configuration of the living network is completed (S78) when the primary network manager is not searched (S77).

On the other hand, the network manager can get a registered device list (RDL) from the other network managers using the GetDeviceList service (0xFF34). In the LnCP network having the plurality of network managers, the primary network manager assigns an address to a new device. At this time, the secondary network managers receive a NotiAddressConfirm service of the device to confirm that the logical address is assigned to the new device.

Also, the primary network manager that assigns the address to the new device transmits the DeviceAddReq message of a DeviceAdd service (0xFF31) to the other network managers. The other network managers that received the DeviceAddReq message add the corresponding device to the homenet profile thereof, get the profile of the device whose information is modified using the GetNetProfile service (0xFF35), and update the homenet profile thereof.

Then, the primary network manager that deletes a device from the homenet profile notifies all of the network managers connected to the living network that the corresponding device is deleted. For example, the primary network manager deletes a device using a SetDeviceDel service (0xFF1B) and deletes the corresponding device from the homenet profile thereof to notify the DeviceDelReq message of the DevieDel service (0xFF32) to all of the network managers. The network managers that receive the DeviceDelReq message delete information on the corresponding device from the homenet profile thereof.

On the other hand, when information on a device registered in the homenet profile is modified, the primary network manager transmits the DeviceModifyReq message of the DeviceModify service (0xFF33) to the other network managers. The network managers that receive the DeviceModifyReq message get the profile of the device whose information is modified using the GetNetProfile service (0xFF35) and updates the homenet profile thereof.

Also, the primary network manager can get an active device list (ADL) from the other network managers using a GetActiveDeviceList service (0xFF39). A change in the ADL may be directly managed by the primary network manager and the secondary network managers through the alive events of the devices or may be managed using a database synchronizing service among the network managers.

A user can manage clusters in an arbitrary network manager in a state where the plurality of network managers exist. For example, the arbitrary network manager requests a GetClusterList service to the other network managers to obtain the corresponding list.

On the other hand, the network manager in which a new cluster is registered transmits a ClusterAddReq message of a ClusterAdd service (0xFF3A) to the other network managers. The network managers that receive the ClusterAddReq message add the corresponding cluster code and cluster name in the cluster list thereof.

Also, The network manager that deletes a cluster from the cluster list transmits a ClusterDelReq message of a ClusterDel service (0xFF3B) to all of the network managers. The network managers that receive the ClusterDelReq message deletes the corresponding cluster from the cluster list thereof.

Then, the network manager that modifies a cluster in the cluster list transmits a ClusterModify message of a ClusterModify service (0xFF3C) to all of the network managers. The network managers that receive the ClusterModify message modifies the corresponding cluster from the cluster list thereof.

According to the network system management method of the present invention having the above structure, the user can conveniently perform remote control and monitor and can effectively manage and control all of the devices connected to the network without redundancy error on the network to which the plurality of network managers are connected.

As describe above, while the present invention has been disclosed for the purpose of illustration with reference to the aforementioned preferred embodiment, the living network may be referred to as a network of another name and more various appliances can be connected to the living network according to the present invention, and it will be understood by those skilled in the art that the foregoing embodiment can be improved, modified, substituted or added in a variety of ways without departing from the technical spirit and scope of the invention as defined by the appended claims.

1. A network system management method comprising:
when a device to which no address is assigned is connected to a living network in a state where a plurality of network managers are connected to the living network, the device generating a message of requesting an address to be assigned to transmit the message; and
when an arbitrary network manager that receives the message transmits a message for designating an address, the network manager registering the designated address as the address of the device and then, ignoring a message for designating an address received from the other network manager.

2. The network system management method according to claim 1, further comprising the step of the network manager in which the address of the device is additionally registered updating the homenet profile thereof and then, transmitting the homenet profile to the other network manager to update the homenet profile of the network manager.

3. The network system management method according to claim 2, further comprising the step of generating a message informing that information on the corresponding device is deleted and then, transmitting the message to all of the network managers connected to the network to update the homenet profile when the information on the device registered in the homenet profile is deleted.

4. The network system management method according to claim 2, further comprising the step of generating a message informing that information on the corresponding device is modified and then, transmitting the message to all of the network managers connected to the network to update the homenet profile when the information on the device registered in the homenet profile is modified.

5. The network system management method according to claim 2, wherein the network manager receives information items on all of the devices at one time through interface with the other network manager connected to the network.

6. A network system management method in a network system comprising one or more network managers, the network system management method comprising:
a network manager that newly participates in the network checking other network managers exist on the network;
the network manager setting itself as a primary network manager when it is determined that the other network managers do not exist; and
the network manager notifying the set result to devices that participate in the network.

7. The network system management method according to claim 6, further comprising the step of the network manager searching whether another primary network manager exists when it is determined that the other network managers exist on the network.

8. The network system management method according to claim 7, further comprising the step of the network manager checking whether the other primary network manager has a higher network management function version than the network management function version thereof when it is determined that the other primary network manager exists.

9. The network system management method according to claim 8, further comprising the step of the network manager setting the other primary network manager as a primary network manager when it is determined the network management function version of the other primary network manager is higher than the network management function version thereof and setting itself as a primary network manager and setting the other primary network manager as a secondary network manager when it is determined that the network management function version of the other primary network manager is not higher than the network management function version thereof.

10. The network system management method according to claim 9, further comprising the step of notifying the set result to devices that participate in the network.

11. A network system management method comprising:
when a device to which no address is assigned is connected to a network in a state where a primary network manager and secondary network managers are connected to the network, the primary network manager assigning an address of the device to register the address in a homenet profile; and
the device to which the address is assigned notifying the assigned address to the other secondary network managers connected to the network through a transmission message.

12. The network system management method according to claim 11, wherein, when the plurality of secondary network managers exist in a state where connection of the primary network manager to the network is released, network management function versions of the secondary network managers are compared with each other so that an arbitrary secondary network manager whose network management function version is higher is selected and set as a primary network manager.

13. The network system management method according to claim 11, wherein the primary network manager and the secondary network managers exchange registered device lists to synchronize the registered device lists.

14. The network system management method according to claim 11, wherein the primary network manager and the secondary network managers exchange active device lists to synchronize the active device lists.

15. The network system management method according to claim 11, wherein the primary network manager and the secondary network managers exchange cluster lists to synchronize the cluster lists.

16. The network system management method according to claim 11, further comprising the primary network manager transmitting the assigned address of the device to the secondary network managers to register the address in a homenet profile of the secondary network managers.

17. A method of assigning addresses to network devices, the method comprising:
the devices receiving new addresses from a primary network manager of a network;
the devices storing the received new addresses in addresses thereof; and
the devices notifying the received and stored new addresses to other secondary network managers connected to the network.
